(19) United States
(12) Patent Application Publication
(10) Pub. No.: US 2007/0147835 A1
(43) Pub. Date: Jun. 28, 2007

(54) Device and method for controlling optical transmitters in WDM-PON system

(75) Inventors: Sang-Ho Kim, Seoul (KR); Seong-Taek Hwang, Pyeongtaek-si (KR); Kwan-Soo Lee, Seoul (KR); Yun-Je Oh, Yongin-si (KR); Jae-Hoon Lee, Seoul (KR)

Correspondence Address: CHA & REITER, LLC, 210 ROUTE 4 EAST STE 103, PARAMUS, NJ, 07652, US

(73) Assignee: Samsung Electronics Co., LTD

(21) Appl. No.: 11/606,666

(22) Filed: Nov. 30, 2006

(30) Foreign Application Priority Data
Dec. 26, 2005 (KR) 2005-129823

(51) Int. Cl. H04J 14/00

(52) U.S. Cl. 398/71

(57) ABSTRACT

A method for controlling optical transmitters in a Wavelength Division Multiplexed (WDM)-Passive Optical Network (PON) system includes the steps of: determining the existence of an upward optical signal to control an optical transmitter provided for each corresponding Optical Node Terminal (ONT) to be turned on/off in an Optical Line Termination (OLT); and monitoring the state of a transmission buffer within an Ethernet switch to control a corresponding optical transmitter to be turned on/off in accordance with the state of the transmission buffer in each of the ONTs.

### CLAIM OF PRIORITY

This application claims priority to an application entitled “Device and Method for Controlling Optical Transmitters in WDM-PON System,” filed with the Korean Intellectual Property Office on Dec. 26, 2005 and assigned Serial No. 2005-129823, the contents of which are incorporated herein by reference.

### BACKGROUND OF THE INVENTION

1. Field of the Invention

The present invention relates to a Wavelength Division Multiplexed (WDM)-Passive Optical Network (PON) system, and more particularly to a device and method for controlling optical transmitters in an Optical Line Termination (OLT) or Optical Node Terminal (ONT).

2. Description of the Related Art

WDM-PON provides ultra high-speed broadband communication services by assigning a unique wavelength to each subscriber. An improvement in communication capacity and user's security are facilitated due to the assignment of a unique wavelength for each subscriber. Further, a separate wavelength is assigned to a new subscriber to easily accept new subscribers so that a system can be easily expanded.

The WDM-PON has been implemented using an optical transmitter so as to reduce installation costs of the WDM-PON. To this end, an optical transmitter needs to output different wavelengths during various conditions. To this end, various methods have been suggested. First, there is a method of transmitting only a specific wavelength through an optical wavelength mux/demux (generally, AWG: Array Waveguide Grating) using a broadband light source as the optical transmitter. This type of method is referred to as WDM-PON using a spectrum-sliced light source. Also, there is another method of transmitting using a wavelength of a Broadband Light Source (BLS) by injecting the wavelength of a optical transmitter.

As Ethernet technology is generally developed as a standard communication scheme of Local Area Network (LAN), it has been also applied to the communication protocol of a PON optical subscriber network system. That is, a system for directly transmitting/receiving IP packet data between an ONT and an OLT has been commercialized by standardizing a new Ethernet Passive Optical Network-Medium Access Control (PON-MAC), such as an Ethernet-Passive Optical Network (E-PON) system.

FIG. 1 is a block diagram showing a configuration of a WDM-PON system using a general spectrum-sliced light source. As shown, a plurality of ONTs 11 is connected to one OLT 10 through a WDM-PON link. The OLT 10 includes a plurality of optical transceivers 104 for performing photoelectric conversion of a transmission/reception signal for each subscriber, and WDM filters 106 for filtering input/output optical signals of the respective optical transceivers 104. Downward optical signals output from the plurality of WDM filters 106 are multiplexed in an optical wavelength mux/demux 108 of the WDM-PON to provide them to an optical wavelength mux/demux 124 for distribution in an Optical Distribution Network (ODN) 12 via a transmission optical fiber 122, and demultiplexed in the optical wavelength mux/demux 124 for distribution to the respective ONTs 11. Each of the ONTs 11 includes optical transceivers 114 for performing a photoelectric conversion of transmission/reception signals to OLTs 10, and WDM filters 116 for filtering input/output optical signals of the respective optical transceivers 114. Each of the WDM filters 116 is connected to the optical wavelength mux/demux 124 for distribution.

Each of the ONTs 11 may include Ethernet switches 112 for switching upward/downward Ethernet signals with internet equipments, such as user's personal computers, to be respectively linked with the optical transceivers 114. The OLT 10 may include an Ethernet switch block 102 for switching upward/downward Ethernet signals for subscriber with each of the optical transceivers 104, and a management/processing block 100 for performing an operation of the Ethernet switch block 102 and a general management operation of the OLT 10. The Ethernet switch block 102 of the OLT 10 includes a plurality of Input/Output (I/O) ports 102b-1, . . . , 102b-N connected to the respective optical transceivers 104 for each subscriber, and a switch fabric 102a for switching a signal of each of the I/O ports.

In the WDM-PON system as shown in FIG. 1, a broadband light source may be used as a light source for each optical transmitter. If the broadband light source modulated in the optical transmitter passes through the optical wavelength mux/demux 108, the optical transmitters can respectively receive assigned wavelengths determined by the optical wavelength mux/demux 108. A Light Emitting Diode (LED) or Reflective Semiconductor Optical Amplifier (RSOA) may be used as the broadband light source.

FIG. 2 is a block diagram showing a configuration of a WDM-PON system using a general wavelength-locked light source. As shown, an OLT 20 includes an Ethernet switching block 202, optical transceivers 204, filters 206, an optical wavelength mux/demux 208, a plurality of ONT 21 each including Ethernet switches 212, optical transceivers 214, and filters 216. The OLT 20 shown in FIG. 2 includes upward and downward light source 209a and 209b for respectively generating an upward band amplified spontaneous emission (band A) and a downward band amplified spontaneous emission (band B) so as to produce a wavelength-locked light source using a Broadband Light Source (BLS), and may further include a 2×2 optical coupler 209c for coupling light radiated from the respective upward and downward light sources 209a and 209b to a transmission optical fiber 122. Further, the connection between the OLT 10 and the ONT 21 is accomplished through a 1×N Optical Distribution Network (ODN) 12. Korean Patent Application No. 2004-115373(US2006-0140548-A1 and U.S. Pat. No. 7,073,986 B1), entitled Optical Transceiver and Passive Optical Subscriber Network, which has been previously filed by the present applicant, discloses such a WDM-PON system.

Referring to FIG. 2, since upward and downward signals respectively use bands A and B, a wavelength division multiplexer for distinguishing between upward and downward optical signals is required. Further, upward and downward optical transmitters must use A-band and B-band optical transmitters in a case of upward and downward, respectively. A Fabry-Perot Laser Diode (FP-LD) or RSOA may be used as such an optical transmitter.

As shown in FIGS. 1 and 2, the optical transmitters of the OLTs 10 and 20 always maintain an ON state regardless of the existence of transmission data in the WDM-PON systems in which the Ethernet switching blocks, each including Ethernet MAC, are connected. As such, there is a drawback in that the optical transmitter configured as a semiconductor laser diode and a laser diode driver chip consume unnecessary electric power. Particularly, there is a problem of inefficiency of power consumption in the OLTs 10 and 20 due to a plurality of optical transmitters.

### SUMMARY OF THE INVENTION

Accordingly, the present invention has been made to solve the above-mentioned problems occurring in the prior art and provides additional advantages, by providing a device and a method for controlling optical transmitters in a WDM-PON system to improve the efficiency of power consumption in a bi-directional WDM-PON system using an existing Ethernet switch.

According to an aspect of the present invention, there is provided a method of controlling optical transmitters in a Wavelength Division Multiplexed (WDM)-Passive Optical Network (PON) system. The method includes the acts of: determining the existence of an upward optical signal to control an optical transmitter provided for each corresponding Optical Node Terminal (ONT) to be turned on/off in an Optical Line Termination (OLT); and monitoring the state of a transmission buffer within an Ethernet switch to control a corresponding optical transmitter to be turned on/off in accordance with the state of the transmission buffer in each of the ONTs.

According to another aspect of the present invention, there is provided a device for controlling optical transmitters of an OLT in a WDM-PON system which includes: optical transceivers for performing photoelectric conversion of a transmission/reception signal provided for each ONT; an Ethernet switching block provided with a plurality of Input/Output (I/O) ports connected to the optical transceivers for each subscriber, a switch fabric for switching a signal of each of the I/O ports and a plurality of registers connected to the respective I/O ports such that status information of a transmission/reception buffer of a corresponding I/O port is recorded so as to enable Ethernet communications of the ONTs; and a management/processing block for reading status information recorded in each of the register of the Ethernet switching block to identify the state of existence of reception data, and turning off an optical transmitter corresponding to an ONT with no reception data.

### BRIEF DESCRIPTION OF THE DRAWINGS

The above features and advantages of the present invention will be more apparent from the following detailed description taken in conjunction with the accompanying drawings, in which:

FIG. 1 is a block diagram showing a configuration of a WDM-PON system using a general spectrum-sliced light source;

FIG. 2 is a block diagram showing a configuration of a WDM-PON system using a general wavelength-locked light source;

FIGS. 3a and 3b are block diagrams showing configurations of an ONT and an OLT in a WDM-PON system according to a first embodiment of the present invention, respectively;

FIG. 4 is a block diagram showing a configuration of an OLT in a WDM-PON system according to a second embodiment of the present invention; and

FIG. 5 is a flowchart illustrating an operation of controlling an OLT optical transmitter in the WDM-PON system according to the second embodiment of the present invention.

### DETAILED DESCRIPTION

Hereinafter, exemplary embodiments of the present invention will be described with reference to the accompanying drawings. In the following description, the same elements will be designated by the same reference numerals although they are shown in different drawings. Further, for the purposes of clarity and simplicity, a detailed description of known functions and configurations incorporated herein will be omitted as it may make the subject matter of the present invention rather unclear.

Generally, since network use time is variable at a subscriber node and particularly, much of time is not relatively used in a passive optical subscriber network unlike a backbone network or enterprise network, there may occur a problem in that the efficiency of a system having multiple optical transmitters is lowered by operating an optical transmitter assigned to a corresponding subscriber from an OLT. Thus, according to the teachings of the present invention when it is determined that an optical subscriber does not use the network in the present invention, an OLT may turn off an optical transmitter with a wavelength that is previously assigned to a corresponding optical subscriber, or a corresponding ONT may also turn off its own optical transmitter.

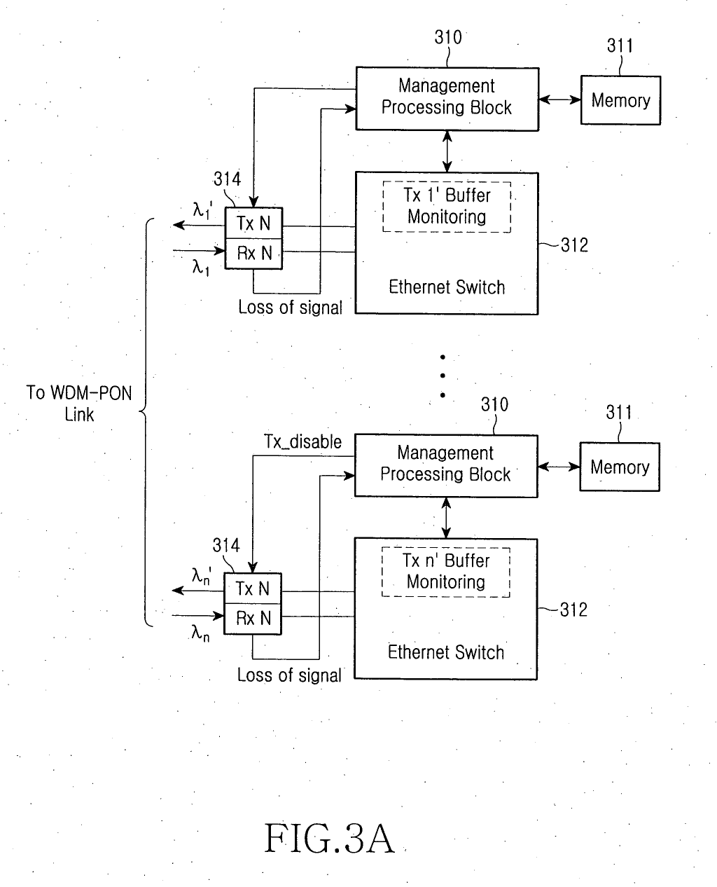

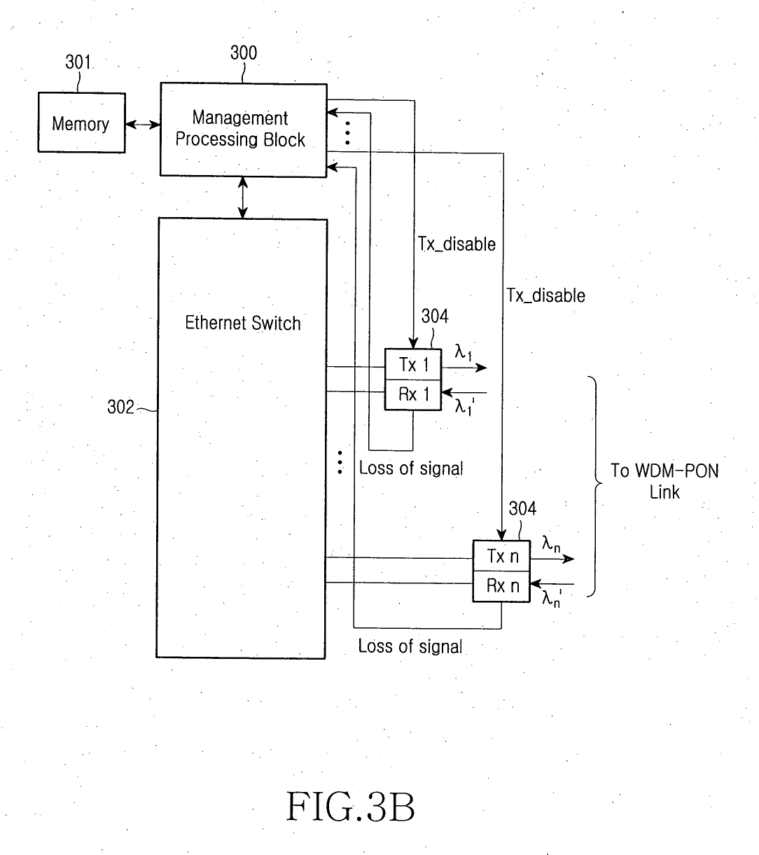

FIGS. 3a and 3b are block diagrams showing configurations of an ONT and an OLT in a WDM-PON system according to a first embodiment of the present invention, respectively.

Referring to FIG. 3a, the ONT according to the present invention includes Ethernet switches 312, management/processing blocks 310, and optical transceivers 314 for transmitting/receiving an optical signal with a frequency assigned to each corresponding ONT. Each optical transceiver 314 is connected to each management/processing block 310 so as to receive the operation on/off control in conjunction with the Ethernet switch 312. Moreover, memory 311 for storing various programs and information required for the operation is provided inside/outside of the management/processing blocks 310 of the ONT.

Referring to FIG. 3b, the OLT according to the present invention includes an Ethernet switching block 302, a management/processing block 300, and optical transceivers 304 assigned to each subscriber. An optical transceiver 304 is connected to the management/processing block 300 so as to receive the operation on/off control in conjunction with the Ethernet switching block 302. Moreover, a memory 301 for storing various programs and information required for the operation is provided inside/outside the management/processing block 300 of the OLT.

In operation, the Ethernet switches of the ONT transmit/receive data with the Ethernet switching block of the OLT in the WDM-PON system. If the Ethernet switch of the ONT transmits data, the MAC PHY of a corresponding reception port receives the data to provide it to a reception buffer. Thereafter, the data passes through a switch fabric and then transmitted to a target path via other ports. Even if there is no data transmitted from the ONT, a corresponding Ethernet switch of the ONT is designed through standardization such that it continuously transmits idle signal data so as to maintain synchronization with Ethernet MAC PHY of the Ethernet switching block of the OLT. Data transmitted/received through an optical fabric line between the OLT and the ONT may generally use “Fast Ethernet (100Base-FX, 100 Mbps)” type with IEEE 802.3u standard, and may be upgraded to a speed of 1 Gbps or more depending on the quantity of data required hereafter.

When there is no need for turning on the optical transmitter of a corresponding subscriber because a network is not used for a certain period of time in the ONT, the corresponding optical transmitter are turned off according to the present invention. In this case, each of the ONTs first monitors the state of a transmission buffer within its own Ethernet switch for a certain period of time. If it is determined that there is no transmission data, the ONT transmits an OFF signal (Tx_disable=‘high’) to the corresponding optical transmitter to turn it off until new transmission data is input to a data buffer.

When a specific ONT uses the network in such a state, transmission data are primarily accumulated into a corresponding transmission buffer within the Ethernet switch of a corresponding ONT, and a corresponding management/processing block can recognize the state of the transmission buffer. Thereafter, the management/processing block of the corresponding ONT turns on the optical transmitter by providing an optical transmitter ON signal (Tx_disable=‘low’) in order to start current communications with an upward optical transmitter λ_{1′}, . . . , or λ_{n′}. If the optical transmitter of the corresponding ONT is turned on, a corresponding optical receiver Rx 1, . . . , or Rx n of the OLT recognizes a corresponding upward optical signal to transmit this information (Loss Of Signal=‘low’) to the management/processing block of the OLT. Thereafter, the management/processing block of the OLT transmits the optical transmitter ON signal (Tx_disable=‘low’) to the corresponding optical transmitter to setup a link. As such, after having setup the WDM-PON link, the ONT can use the network.

Since the aforementioned Loss Of Signal (LOS) output terminals and ‘Tx_disable’ input terminals are designed in accordance with a standard in various kinds of optical transceiver types, such as currently commercialized Small Form-factor Pluggable (SFP), and registers for monitoring transmission/reception data buffers are implemented within the Ethernet switch, a system for enhancing power consumption efficiency can be simply implemented through the configuration and operation according to the present invention.

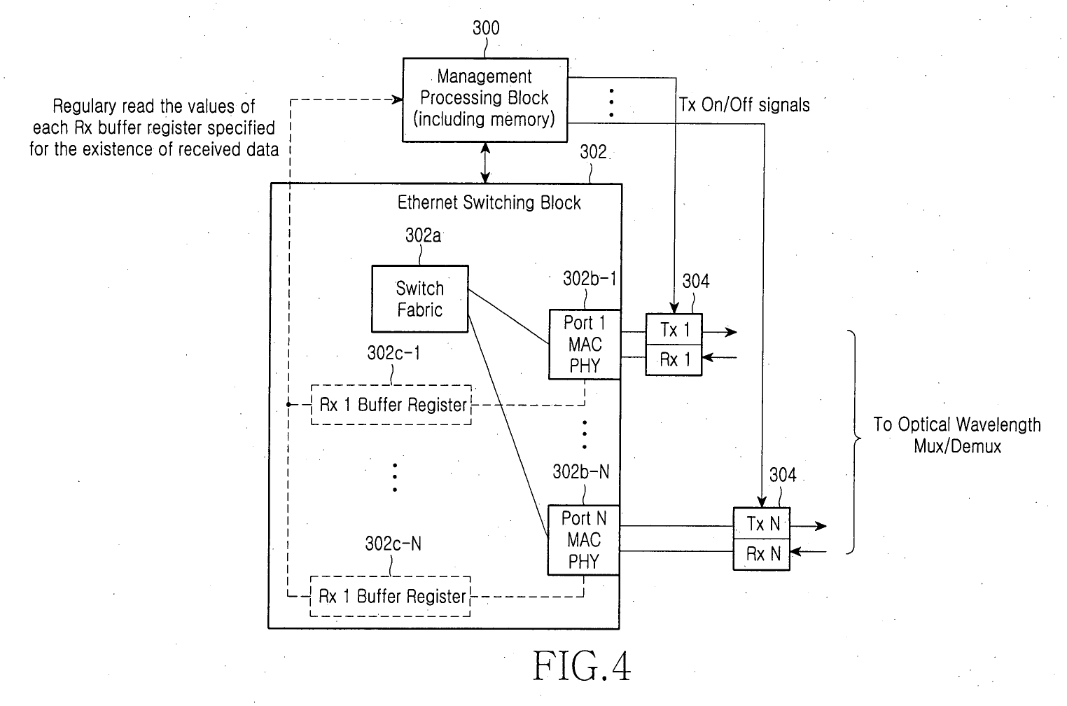

FIG. 4 is a block diagram showing a configuration of an OLT in a WDM-PON system according to a second embodiment of the present invention. As shown, the OLT according to the second embodiment of the present invention includes an Ethernet switching block 302, a management/processing block 300, and optical transceivers 304 assigned to each subscriber. An optical transmitter of each optical transceiver 304 is connected to the management/processing block 300 so as to receive the operation on/off control thereof together with the Ethernet switching block 302. The Ethernet switching block 302 includes a plurality of I/O ports 302b-1, . . . and 302b-N connected to the respective optical transceivers for each subscriber, and a switch fabric 302a for switching a signal of each of the I/O ports. The Ethernet switching block 302 is provided with a plurality of registers 302c-1, . . . and 302c-N respectively connected to the I/O ports 302b-1, . . . and 302b-N so as to record state information of a transmission/reception buffer of a corresponding I/O port. The state information recorded in the plurality of registers 302c-1, . . . and 302c-N is provided to the management/processing block 300. Accordingly, the management/processing block 300 identifies and turns off currently unused optical transmitters.

An operation of the OLT according to the present invention will be described. First, in a case where upward data input to an optical receiver is input to Ethernet MAC PHY of a corresponding port of the Ethernet switching block 302 and transmitted to a corresponding reception buffer in a parallel data type, there is recorded the state of reception data existence within the reception buffer of the corresponding port in a register for monitoring the state of the reception buffer essentially embedded in a switch controller (not shown) of the Ethernet switching block 302. The content recorded in the register is read by the management/processing block 300 through an internal bus connected between the Ethernet switching block 302 and the management/processing block 300. Accordingly, the management/processing block 300 outputs a proper optical transmitter ON/OFF signal to allow the corresponding optical transmitter to be operated.

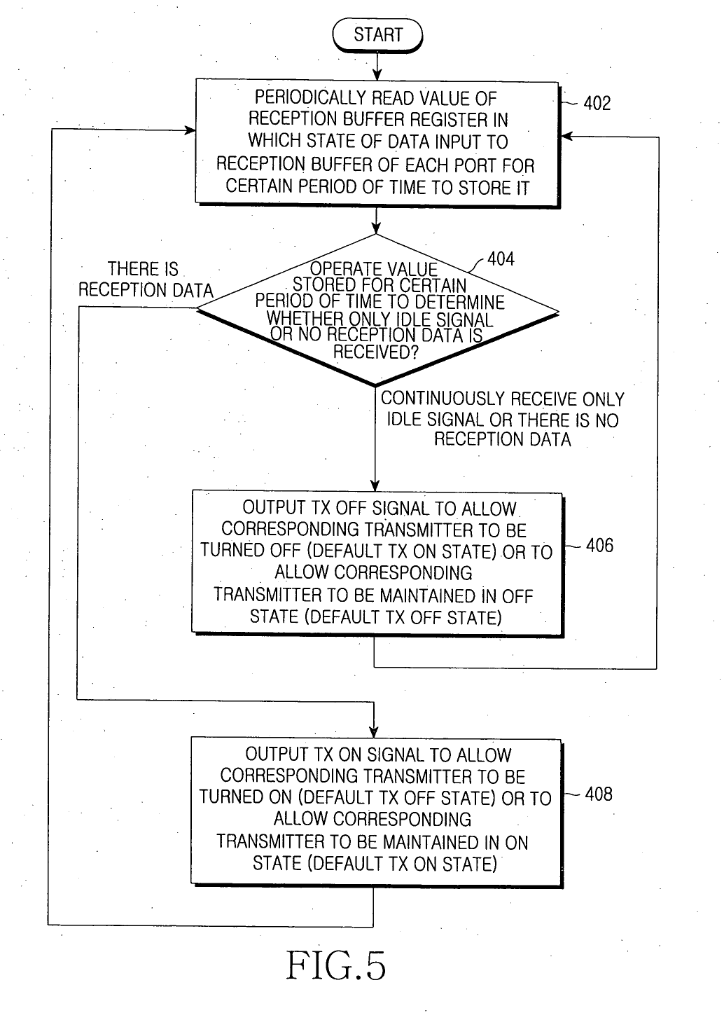

FIG. 5 is a flowchart illustrating an operation of controlling an OLT optical transmitter in the WDM-PON system according to the second embodiment of the present invention. More particularly, FIG. 5 shows the operation steps of the management/processing block 300.

Referring to FIGS. 4 and 5, the management/processing block 300 periodically reads values of the respective reception buffer registers, in which the state of data input to the reception buffer of each port in the Ethernet switching block 302 for a predetermined period of time to store it in an internal memory (not shown) at step 402. Thereafter, the management/processing block 300 reads the values of the respective reception buffer registers, and operates according to the stored values, and then determines whether only an idle signal or no data is received during the predetermined period of time for each port at step 404. If it is determined that no data or only an idle signal is received at step 404, the management/processing block 300 proceeds to step 406. Otherwise (if data is received), the management/processing block 300 proceeds to step 408.

At step 406, the management/processing block 300 outputs a transmission OFF signal to a corresponding optical transmitter to turn it off, and allow the corresponding optical transmitter to be maintained in an OFF state. Thereafter, the management/processing block 300 proceeds to step 402 to repeat the above process.

At step 408, the management/processing block 300 outputs a transmission ON signal to a corresponding optical transmitter to turn it on, and allow the corresponding optical transmitter to be maintained in an ON state if it is currently the ON state. Thereafter, the management/processing block 300 proceeds to step 402 to repeat the above process.

In summary, for the control of an optical transmitter according to the present invention, the management/processing block periodically reads the existence state of reception data of a corresponding reception buffer from a reception buffer register within the Ethernet switching block for a certain period of time to store it in a memory, and then operates it to determine the existence of data of the corresponding reception buffer. If it is determined that there is no reception data in the reception buffer, the management/processing block outputs an OFF signal to the corresponding optical transmitter in a case where it is in an ON state. If it is determined that there is reception data in the reception buffer, the management/processing block outputs an ON signal to the corresponding optical transmitter in a case where it is in an OFF state.

Meanwhile, in cases where the power of an ONT is in an OFF state and where there is no transmission data for a long period of time although the power thereof is turned on, there exists a difference in the state of existence of reception data determined by an OLT. That is, firstly, in a case where the power of the ONT is in an OFF state, no data exists in a reception buffer of a corresponding reception port of the OLT. Secondly, in a case where there is no transmission data for a long period of time although the power of the ONT is turned on, idle pattern data of a certain type exists in the reception buffer of the corresponding reception port of the OLT in accordance with IEEE 802.3z MAC standard. In the present invention, the power of the optical transmitter of the OLT is turned off so as to eliminate unnecessary power consumption of a system and to build an effective system in all the cases.

As describe above, in a method of controlling optical transmitters of an OLT in WDM-PON system, according to the present invention, the ON/OFF states of several optical transmitters used in the WDM-PON system are actively controlled so that the power consumption efficiency of the system can be enhanced. Accordingly, transmission/reception wavelengths are all assigned depending on the number of optical subscribers so that the WDM-PON system with a large number of optical transceivers can be operated more effectively.

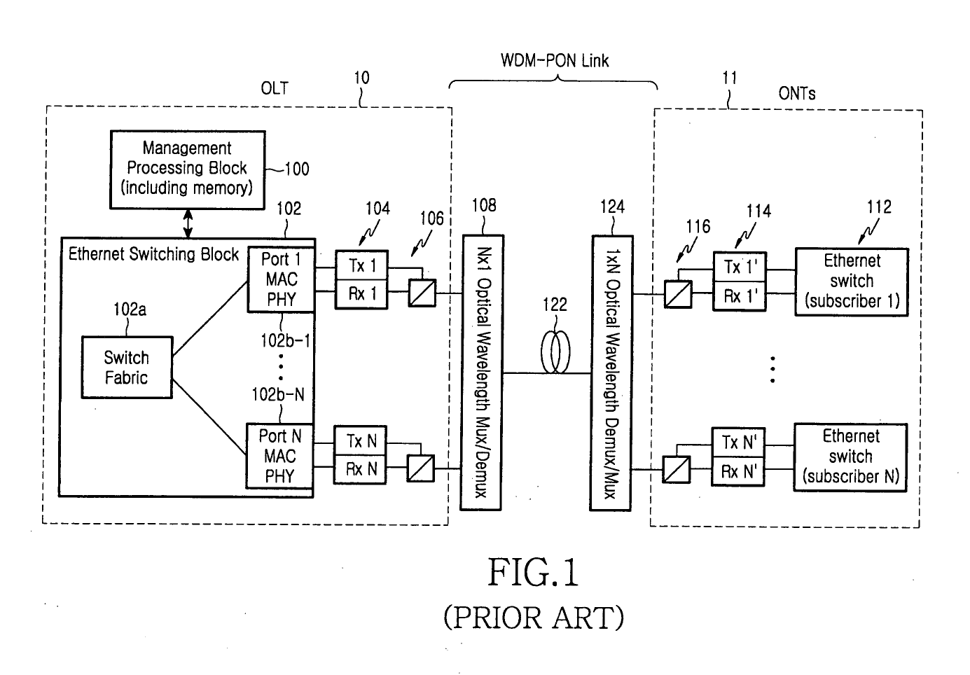

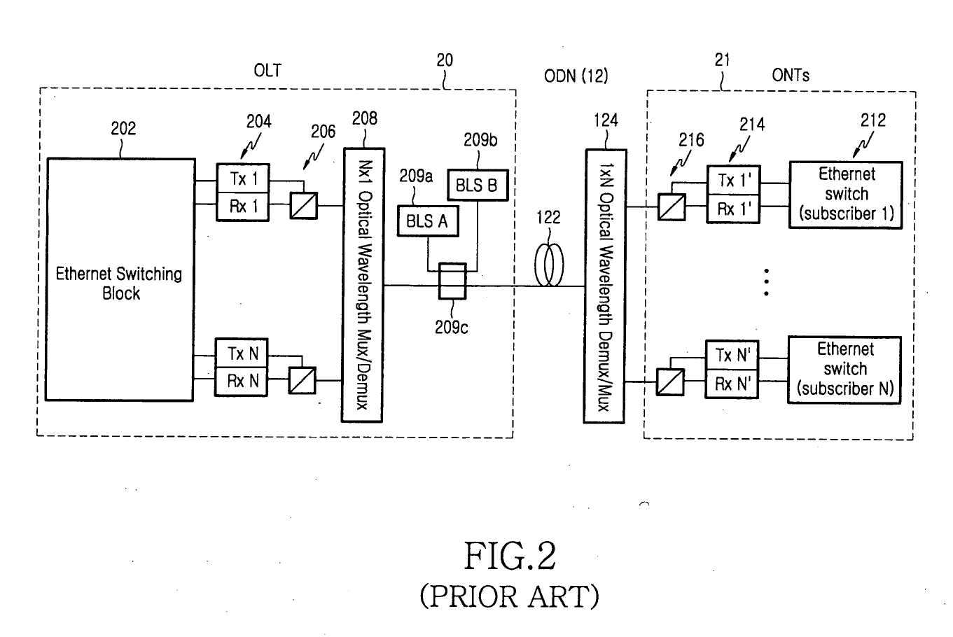

Moreover, the configuration and operation of a device for controlling optical transmitters of an OLT in a WDM-PON system, according to the second embodiment of the present invention, can be accomplished. For example, although an example of controlling the operations of optical transmitters of the OLT has been described in descriptions of the second embodiment of the present invention, operations similar thereto may be applied to the operation of controlling optical transmitters of an ONT in the second embodiment of the present invention. That is, the present invention may be implemented such that the power of a corresponding optical transmitter can be turned on/off by identifying the existence of reception data input to a port of an Ethernet switch in the each ONT. Furthermore, it will be apparent that the OLT of the present invention provided with above-described configuration may employ a structure such as a filter or optical wavelength mux/demux provided to the OLTs in the conventional WDM-PON systems as shown in FIGS. 1 and 2.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for controlling a plurality of optical transmitters in a Wavelength Division Multiplexed (WDM)-Passive Optical Network (PON) system, comprising the steps of:
determining the existence of an upward optical signal to control at least one of the plurality of optical transmitters provided to each corresponding Optical Node Terminal (ONT) to be selectively turned on/off in an Optical Line Termination (OLT); and
monitoring the status of a transmission buffer of an Ethernet switch to control the corresponding optical transmitter to be turned on/off in accordance with the state of the transmission buffer in each of the ONTs.

2. The method as claimed in claim 1, wherein when no data input to the transmission buffer is detected for a predetermined period of time allowing the corresponding optical transmitter to be in an OFF state, and when data input to the transmission buffer is detected, allowing the corresponding optical transmitter to be immediately in an ON state

3. A method for controlling an optical transmitter of an OLT in a WDM-PON system, comprising the steps of:
identifying a reception state of each ONT for whether there is reception data;
converting or maintaining the optical transmitter corresponding to an ONT that is determined to have no reception data in an OFF state; and
converting or maintaining the optical transmitter corresponding to an ONT determined to have reception data in an ON state.

4. The method as claimed in claim 3, wherein the step of identifying the reception state from each of the ONTs periodically determines whether or not there is reception data from each of the ONTs for a predetermined period of time.

5. The method as claimed in claim 4, wherein the step of determining whether or not there is reception data from each of the ONTs uses the value of a register in which state information of a reception buffer of a reception port for each of the ONTs in an Ethernet switch is recorded.

6. The method as claimed in claim 3, wherein the determination that there is no reception data also includes a case where only an idle signal is received from the ONT.

7. A method for controlling an optical transmitter of an ONT in a WDM-PON system, comprising the steps of:
determining a reception state from an ONT;
converting or maintaining the optical transmitter in an OFF state if it is determined that there is no reception data; and
converting or maintaining the optical transmitter in an ON state if it is determined that there is no reception data.

8. A device for controlling a plurality of optical transmitters of an OLT in a WDM-PON system, comprising:
a plurality of optical transceivers performing a photoelectric conversion of a transmission/reception signal provided to each ONT;
an Ethernet switching block provided with a plurality of Input/Output (I/O) ports connected to the optical transceivers for each subscriber, a switch fabric for switching a signal of each of the I/O ports, and a plurality of registers connected to the respective I/O ports such that state information of a transmission/reception buffer of a corresponding I/O port is recorded so as to enable Ethernet communications of the ONTs; and
a management/processing block reading state information recorded in each of the register of the Ethernet switching block to identify the state of reception data, and turning off one of the optical transmitters corresponding to an ONT with no reception data.

9. The device as claimed in claim 8, wherein the determination that there is no reception data also includes a case where only an idle signal is received from the ONT.
